(19) United States
(12) Patent Application Publication
(10) Pub. No.: US 2007/0263304 A1
(43) Pub. Date: Nov. 15, 2007

(54) Imaging optical system and rangefinder

(75) Inventors: Norihisa Sakagami, Osaka (JP); Takahiro Fujioka, Osaka (JP); Kouei Hatade, Osaka (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NALUX CO., LTD.

(21) Appl. No.: 11/514,183

(22) Filed: Sep. 1, 2006

(30) Foreign Application Priority Data
May 12, 2006 (JP) 2006-134257

(51) Int. Cl. G02B 5/08

(52) U.S. Cl. 359/857; 359/865

(57) ABSTRACT

To provide a compact imaging optical system using reflecting mirrors that can be equipped and used in a vehicle or the like. An imaging optical system according to the invention includes three reflecting mirrors (103, 107, 109) and configured, when an XYZ orthogonal coordinate system using an optical axis at the center of the field of view as Z-axis is determined, so that the optical axis at the center of the field of view and an optical axis of an image surface may be in parallel by changing orientation of the optical axis in a YZ section while maintaining the orientation of the optical axis in an XZ section, wherein a shape of a YZ section of at least one reflecting mirror is made asymmetric with respect to Z-axis of local coordinates of each reflection surface for reducing aberration.

### BACKGROUND OF THE INVENTION

1. Field of the Invention

The present invention relates to an imaging optical system using reflecting mirrors and a rangefinder using the imaging optical system. Specifically, the invention relates to a compact imaging optical system for infrared light using reflecting mirrors and a rangefinder using the imaging optical system.

2. Description of the Related Art

If an imaging optical system for infrared imaging apparatus is realized by transmission optical elements such as lenses, it is necessary to use germanium as a raw material and the price rises.

Accordingly, to realize a low-price imaging optical system, an imaging optical, system using reflecting mirrors is preferable. An imaging optical system using reflecting mirrors is disclosed in WO2002/084364, for example.

However, a compact imaging optical system using reflecting mirrors that can be equipped and used in a vehicle or the like has not been developed.

Therefore, there is the need for a compact imaging optical system using reflecting mirrors that can be equipped and used in a vehicle or the like.

### SUMMARY OF THE INVENTION

An imaging optical system according to the invention includes three reflecting mirrors and configured, when an XYZ orthogonal coordinate system using an optical axis at the center of the field of view as Z-axis is determined, so that the optical axis at the center of the field of view and an optical axis of an image surface may be in parallel by changing orientation of the optical axis in a YZ section while maintaining the orientation of the optical axis in an XZ section, wherein a shape of a YZ section in local coordinates of at least one reflecting mirror is made asymmetric with respect to Z-axis of the local coordinates, for reducing aberration.

Since the imaging optical system is configured so that the optical axis at the center of the field of view and the optical axis of the image surface may be in parallel by changing orientation of the optical axis in the YZ section, the system becomes compact. Further, since the field of view is not changed even when the imaging optical system is rotated around the Z-axis, focusing can be performed while the imaging optical system is rotated around the Z-axis with a screw or the like.

FIG. 28 shows an example of the imaging optical system in which the optical axis at the center of the field of view and the optical axis of the image surface are not in parallel. FIG. 29 shows the optical system in FIG. 28 when coordinates are set with reference to the optical axis of the image surface. FIG. 30 shows the imaging optical system in FIG. 29 rotated to 180 degrees around the optical axis of the image surface. According to FIGS. 29 and 30, the directions of the optical axis at the center of the field of view are different, and focusing can not be performed while the imaging optical system is rotated around the Z-axis (optical axis) with a screw or the like.

Further, since the shapes of YZ sections of the three reflecting mirror are made asymmetric with respect to Z-axis for reducing aberration, comatic aberration and astigmatism, which can not be reduced in the sections symmetric with respect to Z-axis, can be reduced.

In an imaging optical system according to one embodiment of the invention, an aperture is provided between two of the reflecting mirrors adjacent along an optical path.

Since the aperture is provided, space for providing a light shielding plate that effectively shield stray light can be secured.

In an imaging optical system according to another embodiment of the invention, the most upstream reflecting mirror along the optical path has a convex surface and the most downstream reflecting mirror along the optical path has a concave surface.

When the most upstream reflecting mirror along the optical path has a convex surface and the most downstream reflecting mirror along the optical path has a concave surface, even a non-relay optical system, an optical system having small F-number is obtained.

An imaging optical system according to another embodiment of the invention is a non-relay optical system that does not perform intermediate imaging.

A compact imaging optical system is obtained using a non-relay optical system that does not perform intermediate imaging.

In an imaging optical system according to another embodiment of the invention, the optical axis at the center of the field of view and the optical axis of the image surface are different in orientation.

Since the optical axis at the center of the field of view and the optical axis of the image surface are different in orientation, light from the object side does not directly enter the image surface.

In an imaging optical system according to another embodiment of the invention, the optical axis at the center of the field of view and the optical axis of the image surface are the same in orientation.

Even when the optical axis at the center of the field of view and the optical axis of the image surface are the same in orientation, light from the object side toward the image surface can be shielded by providing a light shielding plate.

An imaging optical system according to another embodiment of the invention includes a light shielding plate so that the light other than the light from the most downstream reflecting mirror along the optical path may not enter the image surface.

In an imaging optical system according to another embodiment of the invention, the reflecting mirror is made of plastic coated with metal.

Since the reflecting mirror is made of plastic, molding is easy and inexpensive.

An imaging optical system according to another embodiment of the invention is used for infrared light.

The imaging optical system can be realized using no expensive material such as germanium.

In a rangefinder according to the invention is configured so that the imaging optical system according to any one of the above embodiments is rotated to 180 degrees around the optical axis of the image surface.

According to the invention, since only one imaging optical system is used, the cost can be drastically reduced.

### BRIEF DESCRIPTION OF THE DRAWINGS

FIG. 1 shows a configuration of an imaging optical system according to one embodiment of the invention;

FIG. 2 is a YZ sectional view of the imaging optical system shown in FIG. 1;

FIG. 3 is a YZ sectional view of the imaging optical system of Example 1;

FIG. 4 shows a configuration of the imaging optical system of Example 1;

FIG. 5 shows distortion aberration of the imaging optical system of Example 1;

FIG. 6 shows transverse aberration of the imaging optical system of Example 1;

FIG. 7 shows astigmatism of the imaging optical system of Example 1;

FIG. 8 is a YZ sectional view of the imaging optical system of Example 2;

FIG. 9 shows a configuration of the imaging optical system of Example 2;

FIG. 10 shows distortion aberration of the imaging optical system of Example 2;

FIG. 11 shows transverse aberration of the imaging optical system of Example 2;

FIG. 12 shows astigmatism of the imaging optical system of Example 2;

FIG. 13 is a YZ sectional view of the imaging optical system of Example 3;

FIG. 14 shows a configuration of the imaging optical system of Example 3;

FIG. 15 shows distortion aberration of the imaging optical system of Example 3;

FIG. 16 shows transverse aberration of the imaging optical system of Example 3;

FIG. 17 shows astigmatism of the imaging optical system of Example 3;

FIG. 18 is a YZ sectional view of the imaging optical system of Example 4;

FIG. 19 shows a configuration of the imaging optical system of Example 4;

FIG. 20 shows distortion aberration of the imaging optical system of Example 4;

FIG. 21 shows transverse aberration of the imaging optical system of Example 4;

FIG. 22 shows astigmatism of the imaging optical system of Example 4;

FIG. 23 shows a configuration of an imaging optical system as a product according to one embodiment of the invention;

FIG. 24 shows one embodiment of a molded component including a first reflecting mirror and an aperture;

FIG. 25 shows one embodiment of the molded component including a second reflecting mirror and a third reflecting mirror;

FIG. 26 shows another embodiment of the molded component including the second reflecting mirror and the third reflecting mirror;

FIG. 27 shows still another embodiment of the molded component including the second reflecting mirror and the third reflecting mirror.

FIG. 28 shows an example of the imaging optical system in which an optical axis at the center of the field of view and an optical axis of the image surface are not in parallel;

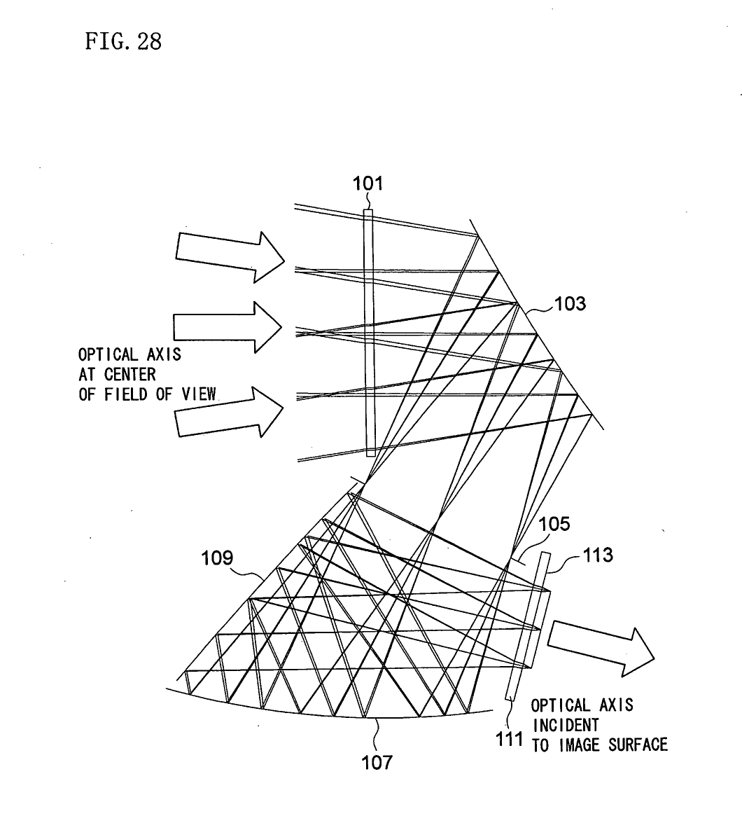

FIG. 29 shows the optical system in FIG. 28 when coordinates are set with reference to the optical axis of the image surface;

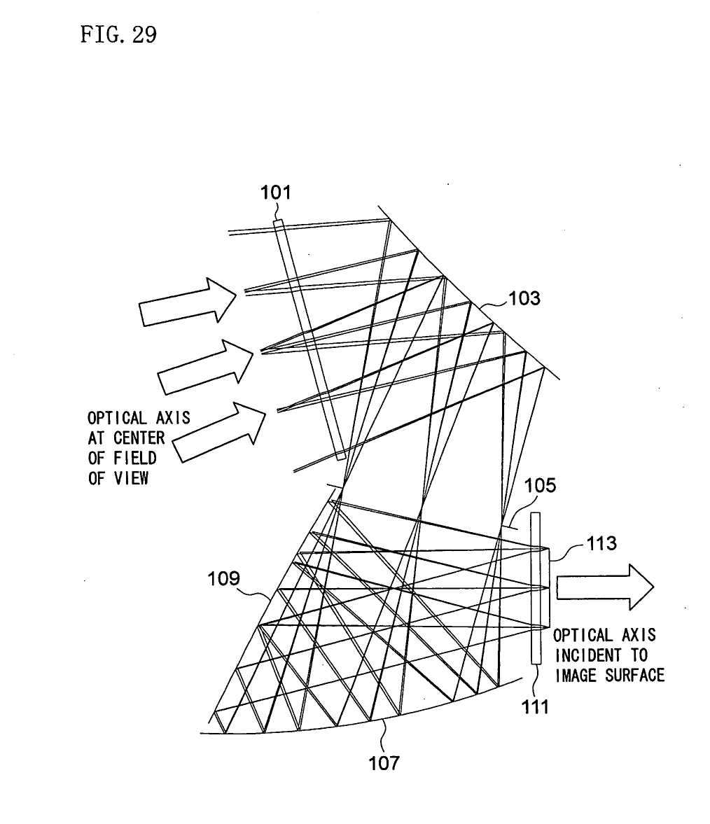

FIG. 30 shows the imaging optical system in FIG. 29 rotated to 180 degrees around the optical axis of the image surface;

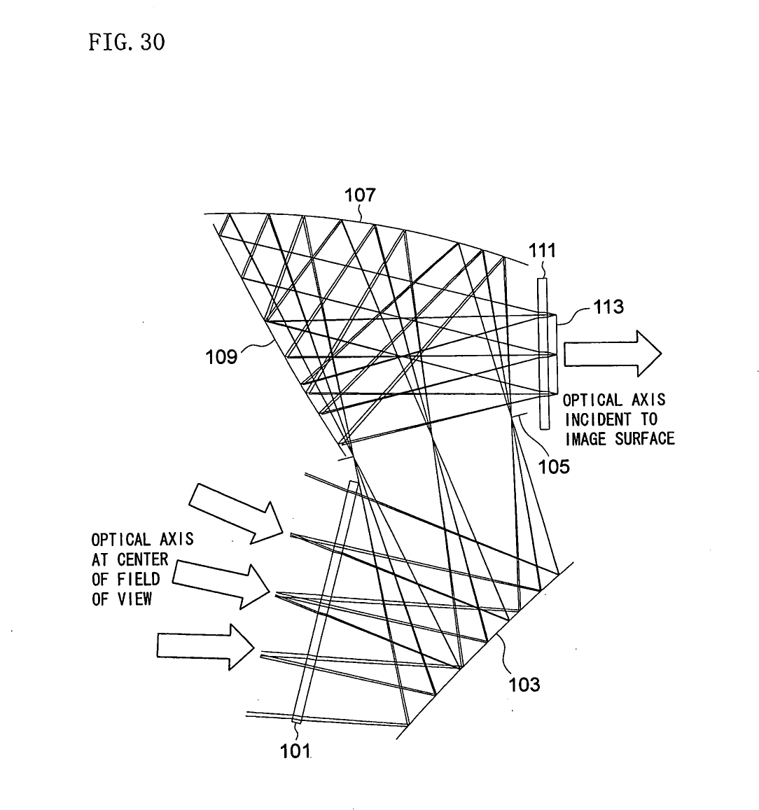

FIG. 31 is a diagram for explanation of optical distortion;

FIG. 32 is a diagram for explanation of transverse aberration;

FIG. 33 shows the concept of a rangefinder; and

FIG. 34 shows a configuration of the imaging optical system of Example 4 and a configuration in which the imaging optical system is rotated to 180 degrees around the optical axis of the image surface.

### DETAILED DESCRIPTION OF THE INVENTION

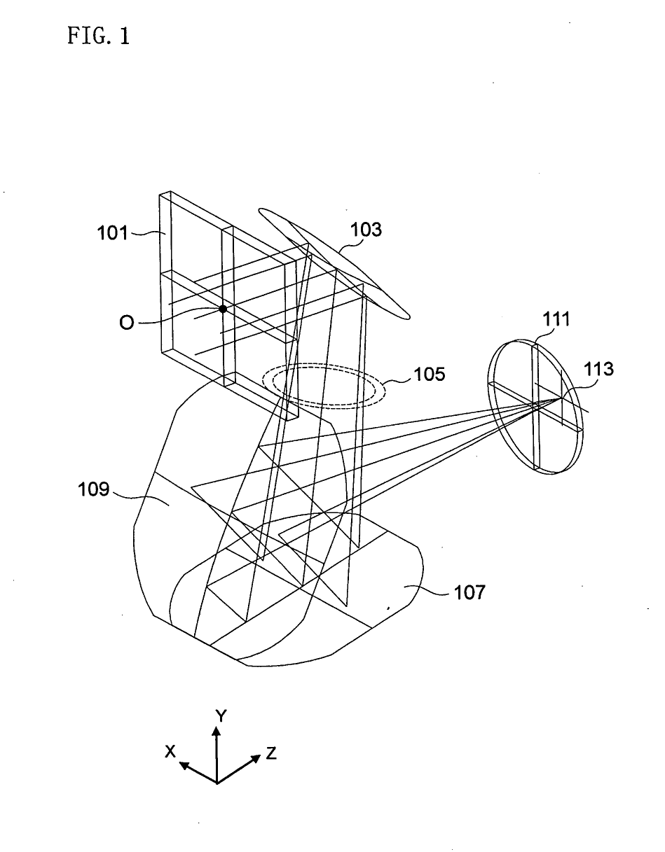

FIG. 1 shows a configuration of an imaging optical system according to one embodiment of the invention. An orthogonal coordinate system in which the optical axis at the center of the field of view is set to Z-axis and the intersection of the Z-axis and the object side surface of a window plate 101 is set to the origin of coordinates O, is determined.

The light passing through the window plate 101 is reflected by a first reflecting mirror 103, a second reflecting mirror 107, and a third reflecting mirror 109, passes through a window plate 111, and then, forms an image on an image surface 113 of an infrared imaging device.

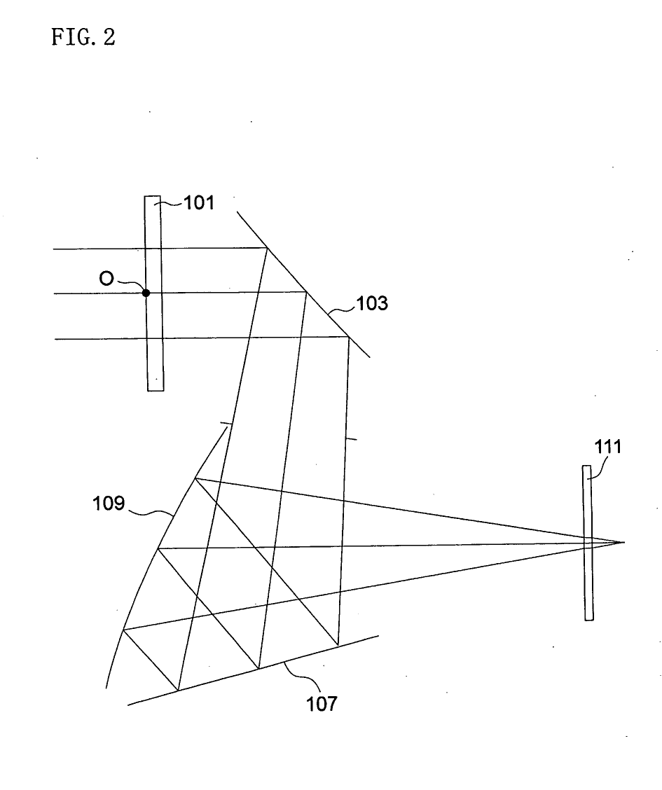

FIG. 2 is a YZ sectional view of the imaging optical system shown in FIG. 1. In the embodiment, an aperture 105 is provided between the first reflecting mirror 103 and the second reflecting mirror 107.

As shown in FIG. 2, while the orientation of the optical axis changes in the YZ section, the orientation of the optical axis does not change in the XZ section. Further, the optical system is configured so that the optical axis at the center of the field of view and the optical axis incident to the image surface may be in parallel.

The reflecting mirror may be formed by coating plastic with metal. Plastic is easy to be molded and the curved shape of the reflecting surface is realized with high precision. When metal such as aluminum, silver, or gold that reflects visible light is used, the imaging optical system can be easily inspected and adjusted with visible light.

As below, Examples 1 to 4 of the invention will be described.

Table 1 shows properties of Examples 1 to 4.

TABLE 1

| Item | | Unit | Example 1 | Example 2 | Example 3 | Example 4 |
|---|---|---|---|---|---|---|
| Sensor size | Horizontal | (mm) | 12 | ← | ← | ← |
| (full value) | Vertical | (mm) | 9 | ← | ← | ← |
| | Diagonal | (mm) | 15 | ← | ← | ← |
| Angle of view | Horizontal | (deg) | 9.92 | 10.05 | 9.99 | 9.99 |
| (half value) | Vertical | (deg) | 7.55 | 7.55 | 7.47 | 7.55 |
| | Rad | (%) | <\|13.2\| | <\|3.41\| | <\|4.08\| | <\|6.16\| |
| Optical | Rad | (%) | <\|3.2\| | <\|3.41\| | <\|4.08\| | <\|6.16\| |
| distortion | Tan | (%) | <\|1.9\| | <\|3.27\| | <\|6.16\| | <\|6.74\| |

| | | | | | |
|---|---|---|---|---|---|
| Fno. | | 2.4 | 2 | 3 | 2.2 |
| BF | (mm) | 30 | 33.1 | 58.7 | 52.1 |
| Relative illumination | (%) | 96.5 | 97.4 | 93.3 | 98.6 |
| Optical layout dimensions | (mm) | 33 × 63 × 37 | 35 × 64 × 45 | 37 × 65 × 62 | 44 × 69 × 61 |
| X × Y × Z | | | | | |

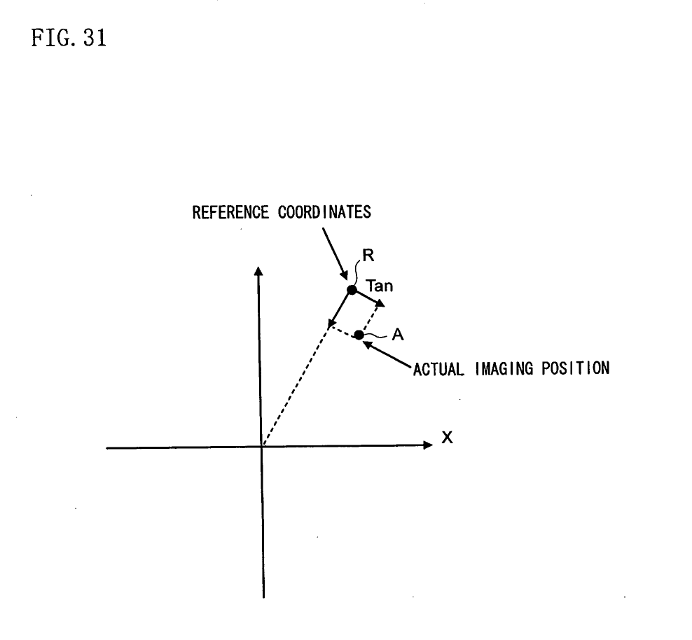

In Table 1, the optical distortion is an amount of displacement of the imaging position relative to the reference coordinates, i.e., an amount of distortion aberration. Rad and Tan are determined as shown in FIG. 31. In Table 1, BF is a distance between the point of intersection of a beam passing through the center of the field of view in the image surface and the reflection surface of the third reflecting mirror and the point of intersection of the beam and the image surface. In Table 1, the relative illumination is a ratio of the smallest quantity of light of the quantities of beams at other than the center of the field of view that pass through the aperture and collect on the image surface to the qualities of beams at the center of the field of view that pass through the aperture and collect on the image surface. In Table 1, the optical layout dimensions are dimensions of the area required by beams passing through the optical effective regions of the respective surfaces from the reflection surface of the first reflecting mirror to the image surface and the aperture and collecting on the respective points on the image surface.

### EXAMPLE 1

Table 2 shows specifications of an imaging optical system of Example 1.

TABLE 2

| | | Origin | Origin | Origin | | | |
|---|---|---|---|---|---|---|---|
| | | Point | Point | Point | Rotation angle | | |
| Surface | | position | position | position | YZ section | Refractive | |
| number | Note | X(mm) | Y(mm) | Z(mm) | (deg) | index | Surface shape |
| Object | Object surface | 0 | 0 | infinity | 0 | 1 | flat surface |
| surface | | | | | | | |
| Surface 1 | Window plate | 0 | 0 | 0 | 0 | 4.003 | flat surface |
| Surface 2 | Window plate | 0 | 0 | 1 | 0 | 1 | flat surface |
| Surface 3 | First reflection | 0 | 0 | 16 | 45 | 1 | XY polynomial |
| | surface | | | | | | surface |
| Surface | Aperture | 0 | −15 | 16 | 90 | 1 | flat surface |
| stop | | | | | | | |
| Surface 5 | Second | 0 | −45 | 16 | 68 | 1 | XY polynomial |
| | reflection | | | | | | surface |
| | surface | | | | | | |
| Surface 6 | Third reflection | 0 | −29.894 | 30.588 | 23 | 1 | XY polynomial |
| | surface | | | | | | surface |
| Surface 7 | Window plate | 0 | −29.894 | 2.588 | 0 | 4.003 | flat surface |
| Surface 8 | Window plate | 0 | −29.894 | 1.588 | 0 | 1 | flat surface |
| Image | Image surface | 0 | −29.894 | 0.588 | 0 | 1 | flat surface |
| surface | | | | | | | |

In Table 2, an origin point position is a position of the origin point of local coordinates of each surface, with reference to the origin point O in FIGS. 1 and 2. The rotation angle is a rotation angle around X-axis of local coordinates and a counterclockwise angle with reference to the coordinate system in FIGS. 1 and 2 in YZ section.

Table 3 shows coefficients that determine the shapes of the first to third reflection surfaces.

TABLE 3

| | Surface 3 | Surface 5 | Surface 6 |
|---|---|---|---|
| X2 | 1.812E−03 | 5.225E−03 | −3.240E−03 |
| Y2 | 1.416E−03 | 5.492E−03 | −1.323E−03 |
| X2Y | −1.203E−05 | −3.508E−05 | −9.490E−05 |
| Y3 | −5.295E−06 | −3.403E−05 | −8.153E−05 |
| X4 | 6.972E−07 | 1.867E−07 | −1.594E−09 |
| X2Y2 | 1.220E−06 | 1.428E−06 | 1.822E−06 |
| Y4 | 3.545E−07 | 1.003E−06 | 8.787E−07 |
| X4Y | −1.817E−08 | −1.064E−08 | −2.992E−08 |
| X2Y3 | −3.058E−08 | −4.187E−08 | −6.847E−08 |
| Y5 | −5.652E−09 | −2.849E−08 | −4.011E−08 |

The shapes of the first to third reflection surfaces can be expressed by the following equation with local coordinates of the respective surfaces.

$$Z = C 4 \times {X}^{2} + C 5 \times XY + C 6 \times {Y}^{2} + C 7 \times {X}^{3} + C 8 \times {X}^{2} Y + C 9 \times {XY}^{2} + C 10 \times {Y}^{3} + C 11 \times {X}^{4} + C 12 \times {X}^{3} Y + C 13 \times {X}^{2} {Y}^{2} + C 14 \times {XY}^{3} + C 15 \times {Y}^{4} + ⋯ + C 66 \times {Y}^{10} \qquad [ Equation 1 ]$$

According to Table 3, the equation expressing the shapes of the first to third reflection surfaces contains terms of powers of odd numbers of Y This indicates that the YZ section shapes of the first to third reflection surfaces are asymmetric with respect to Z-axis of local coordinates. In the embodiment, a change in inclination of the optical axis in the YZ section becomes larger because the aperture is provided between the first reflecting mirror 103 and the second reflecting mirror 107 so as to block stray light. Therefore, when the YZ section shape is symmetric with respect to Z-axis of local coordinates, the comatic aberration or astigmatism becomes larger. Accordingly, the YZ section shape is made asymmetric with respect to Z-axis of local coordinates for reducing the comatic aberration or astigmatism.

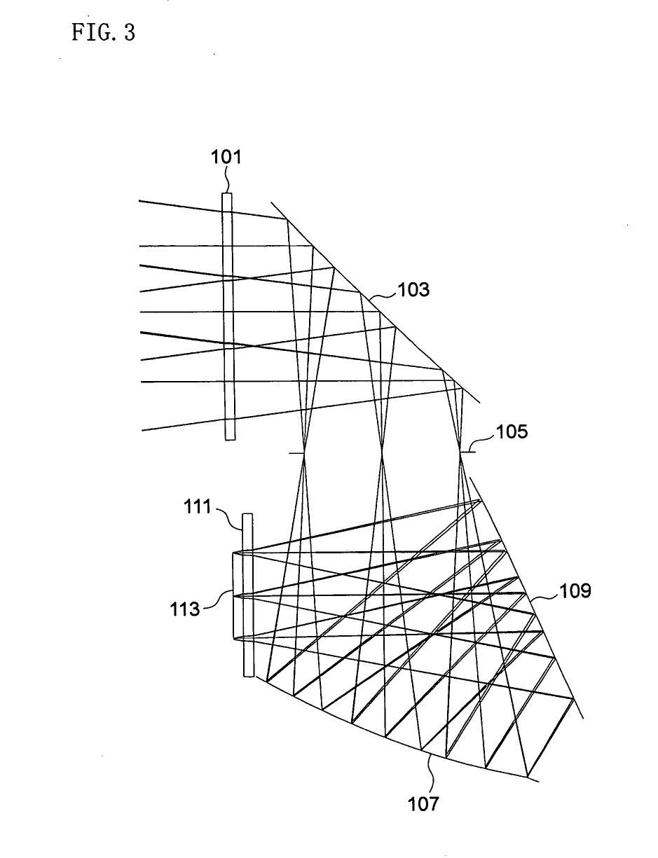

FIG. 3 is a YZ sectional view of the imaging optical system of Example 1. In the embodiment, the optical axis at the center of the field of view and the optical axis of the image surface are in parallel but opposite in orientation.

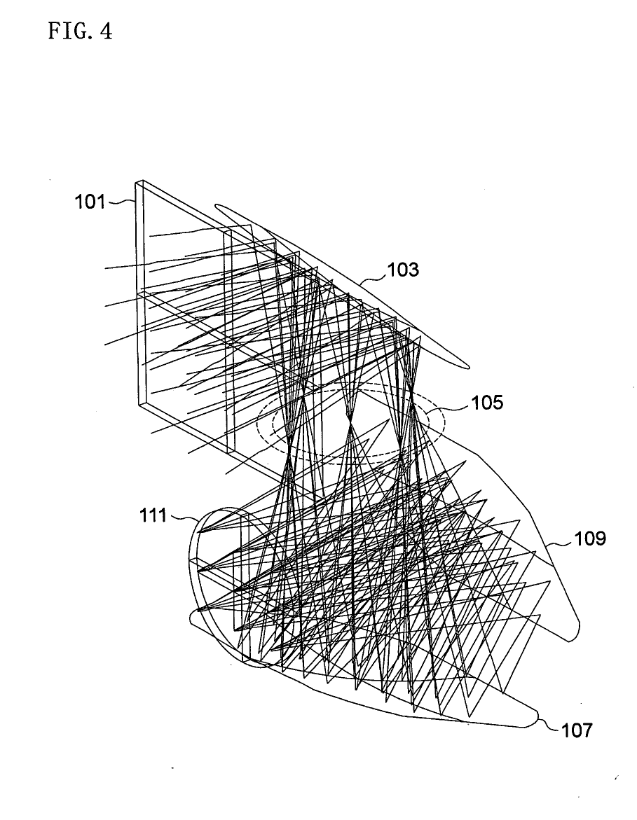

FIG. 4 shows a configuration of the imaging optical system of Example 1.

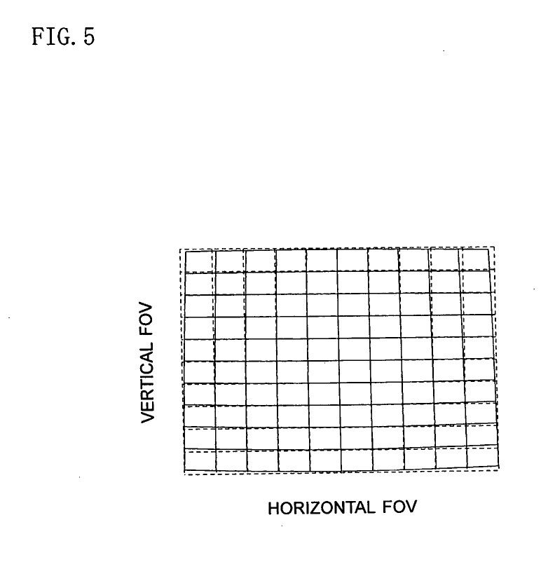

FIG. 5 shows distortion aberration of the imaging optical system of Example 1. The dashed line shows the reference lattice.

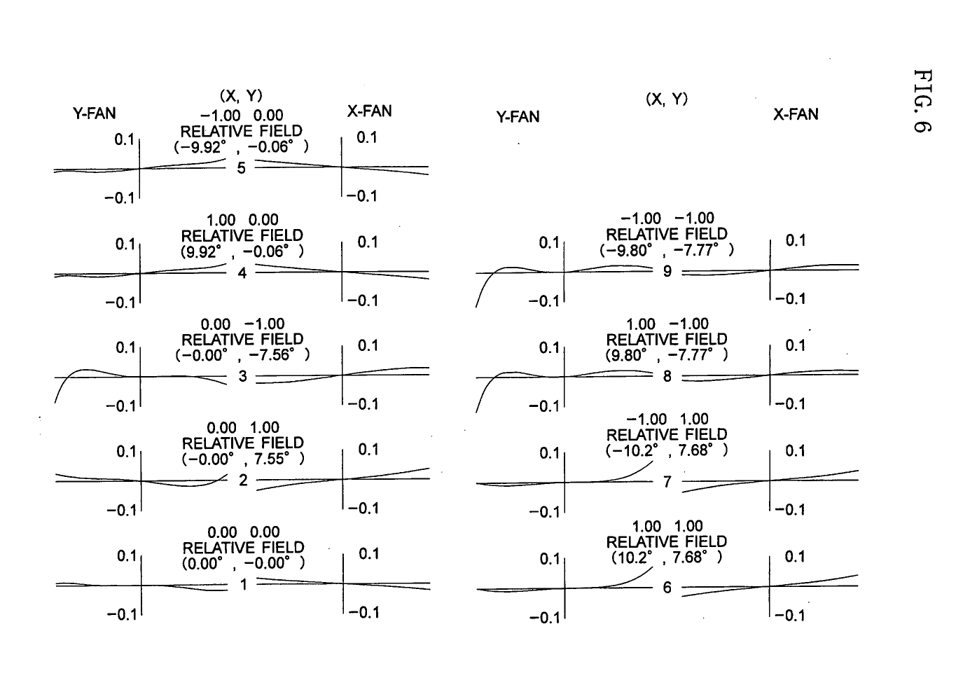

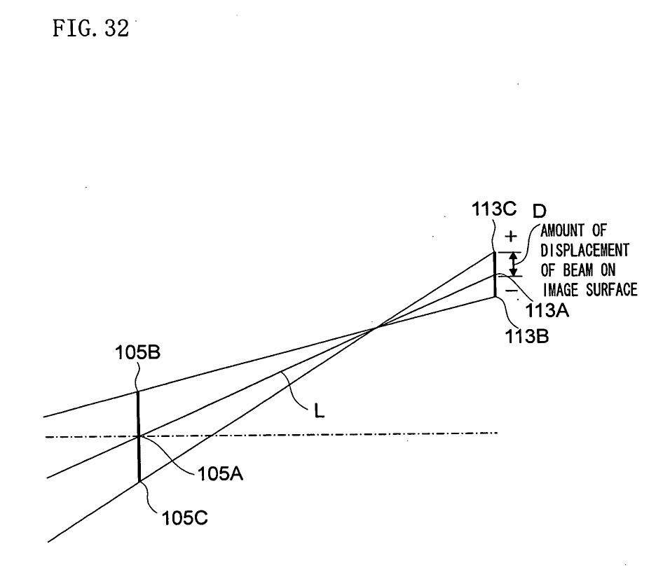

FIG. 6 shows transverse aberration of the imaging optical system of Example 1. FIG. 6 shows transverse aberration with respect to meridional image surface (Y-FAN) and sagittal image surface (X-FAN). The horizontal axis indicates the relative position where the beam passes on the surface stop on the respective image surfaces. The position of principal ray L is zero and the outermost positions in the aperture radial direction is ±1, respectively. The vertical axis indicates amount of displacement D from the principal ray on the image surface, of positions on the image surface through which the beams that have passed through the relative positions pass, when the coordinate on the image surface through which the principal rays L on the respective image surfaces pass is zero (FIG. 32). In FIG. 6, (X,Y) show the positions on the image surface where transverse aberration is observed. That is, FIG. 6 shows transverse aberration with respect to nine points on the image surface represented by (X,Y). The size of the image surface is 12 millimeters in the X-axis direction and 9 millimeters in the Y-axis direction, and (−1,0) indicates coordinates (−6,0) and (0,1) indicates coordinates (0,4.5), for example. An angular vector represents an angle of X-component and Y-component incident in the optical system of beams collecting on a point on the image surface to be observed.

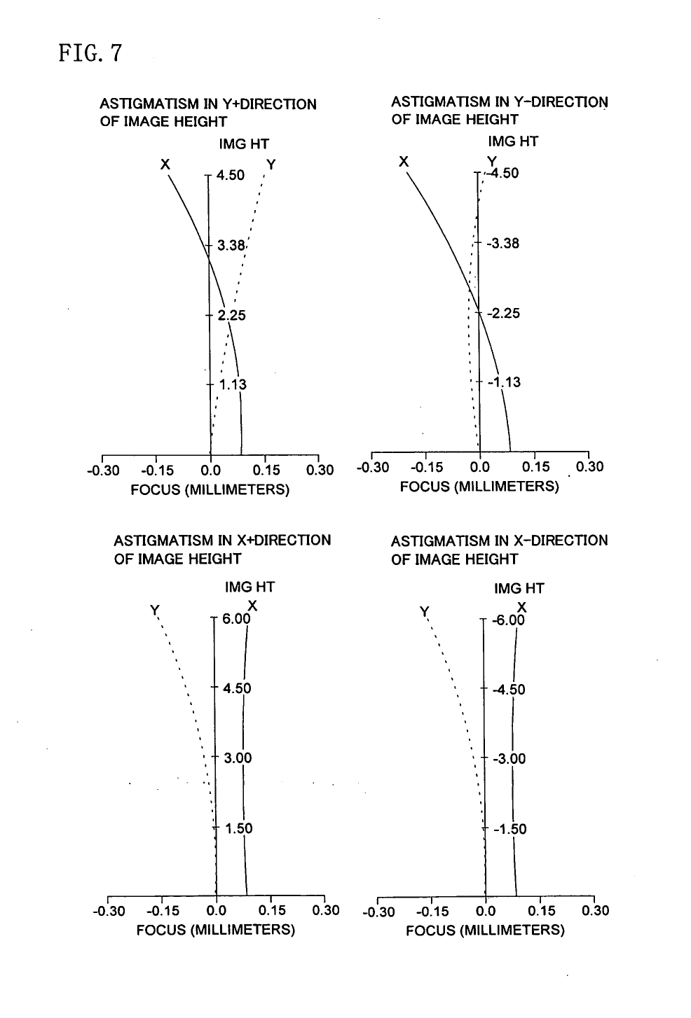

FIG. 7 shows astigmatism of the imaging optical system of Example 1. In FIG. 7, the horizontal axis indicates the position in the Z-axis direction with reference to the image surface and the vertical axis indicates the image height in the X-axis or Y-axis direction. In the drawing showing the image height in the Y-axis direction, the solid line shows the sagittal image surface and the dashed line shows the meridional image surface. In the drawing showing the image height in the X-axis direction, the solid line shows the meridional image surface and the dashed line shows the sagittal image surface.

### EXAMPLE 2

Table 4 shows specifications of an imaging optical system of Example 2.

TABLE 4

| | | Origin | | Origin | Rotation | | |
|---|---|---|---|---|---|---|---|
| | | Point | Origin | Point | angle | | |
| Surface | | position | Point position | position | YZ section | Refractive | |
| number | Note | X(mm) | Y(mm) | Z(mm) | (deg) | index | surface shape |
| Object | Object surface | 0 | 0 | infinity | 0 | 1 | flat surface |
| surface | | | | | | | |
| Surface 1 | Window plate | 0 | 0 | 0 | 0 | 4.003 | flat surface |
| Surface 2 | Window plate | 0 | 0 | 2 | 0 | 1 | flat surface |
| Surface 3 | First reflection | 0 | 0 | 20 | 49 | 1 | XY polynomial |
| | surface | | | | | | surface |
| Surface | Aperture | 0 | −19.805 | 22.783 | 90 | 1 | flat surface |
| stop | | | | | | | |
| Surface 5 | Second | 0 | −46.543 | 26.541 | 72 | 1 | XY polynomial |
| | reflection | | | | | | surface |
| | surface | | | | | | |
| Surface 6 | Third reflection | 0 | −33.594 | 39.045 | 23 | 1 | XY polynomial |
| | surface | | | | | | surface |
| Surface 7 | Window plate | 0 | −33.594 | 11.045 | 0 | 4.003 | flat surface |
| Surface 8 | Window plate | 0 | −33.594 | 10.045 | 0 | 1 | flat surface |
| Image | Image surface | 0 | −33.594 | 5.945 | 0 | 1 | flat surface |
| surface | | | | | | | |

In Table 4, an origin point position is a position of the origin point of local coordinates of each surface, with reference to the origin point O in FIGS. 1 and 2. The rotation angle is a rotation angle around X-axis of local coordinates and a counterclockwise angle with reference to the coordinate system in FIGS. 1 and 2 in YZ section.

Table 5 shows coefficients that determine the shapes of the first to third reflection surfaces.

TABLE 5

| | Surface 3 | Surface 5 | Surface 6 |
|---|---|---|---|
| X2 | 2.10E−03 | 5.15E−03 | −3.27E−03 |
| Y2 | 1.05E−03 | 4.58E−03 | −2.20E−03 |
| X2Y | −6.10E−06 | −3.05E−05 | −6.85E−05 |
| Y3 | −1.44E−06 | −2.49E−05 | −5.53E−05 |
| X4 | 7.85E−07 | 1.38E−07 | −7.39E−08 |
| X2Y2 | 1.03E−06 | 1.30E−06 | 1.26E−06 |
| Y4 | 2.22E−07 | 8.04E−07 | 5.37E−07 |
| X4Y | −1.38E−08 | −9.92E−09 | −2.20E−08 |
| X2Y3 | −2.12E−08 | −4.13E−08 | −5.23E−08 |
| Y5 | −2.90E−09 | −2.59E−08 | −3.04E−08 |

The shapes of the first to third reflection surfaces can be expressed by the following equation with local coordinates of the respective surfaces.

$$Z = C 4 \times {X}^{2} + C 5 \times XY + C 6 \times {Y}^{2} + C 7 \times {X}^{3} + C 8 \times {X}^{2} Y + C 9 \times {XY}^{2} + C 10 \times {Y}^{3} + C 11 \times {X}^{4} + C 12 \times {X}^{3} Y + C 13 \times {X}^{2} {Y}^{2} + C 14 \times {XY}^{3} + C 15 \times {Y}^{4} + ⋯ + C 66 \times {Y}^{10} \qquad [ Equation 2 ]$$

According to Table 5, the equation expressing the shapes of the first to third reflection surfaces contains terms of powers of odd numbers of Y This indicates that the YZ section shapes of the first to third reflection surfaces are asymmetric with respect to Z-axis of local coordinates. In the embodiment, a change in inclination of the optical axis in the YZ section becomes larger because the aperture is provided between the first reflecting mirror 103 and the second reflecting mirror 107 so as to block stray light. Therefore, when the YZ section shape is symmetric with respect to Z-axis of local coordinates, the somatic aberration or astigmatism becomes larger. Accordingly, the YZ section shape is made asymmetric with respect to Z-axis of local coordinates for reducing the somatic aberration or astigmatism.

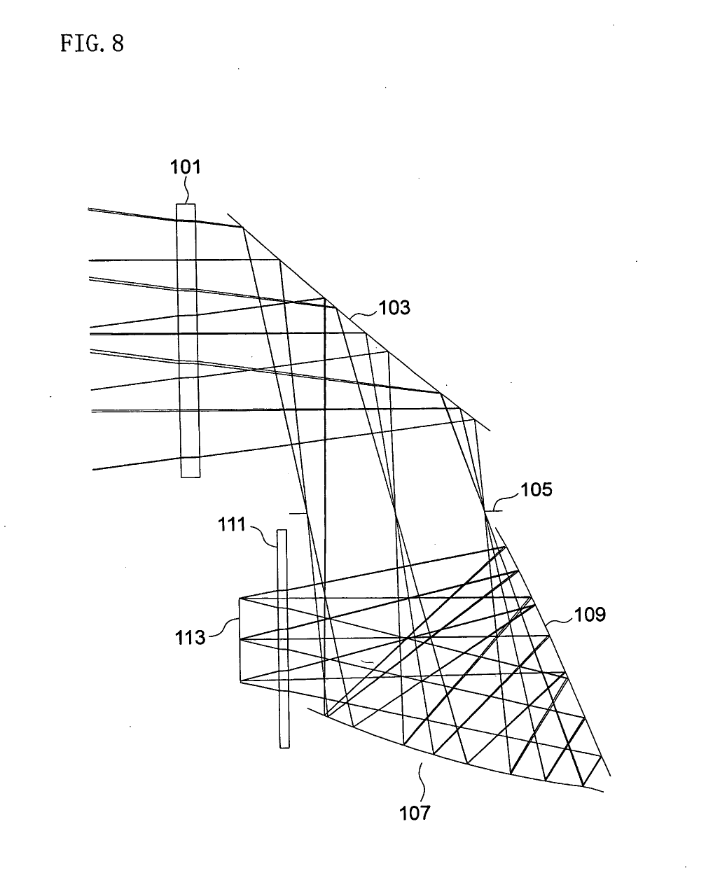

FIG. 8 is a YZ sectional view of the imaging optical system of Example 2. In the embodiment, the optical axis at the center of the field of view and the optical axis of the image surface are in parallel but opposite in orientation.

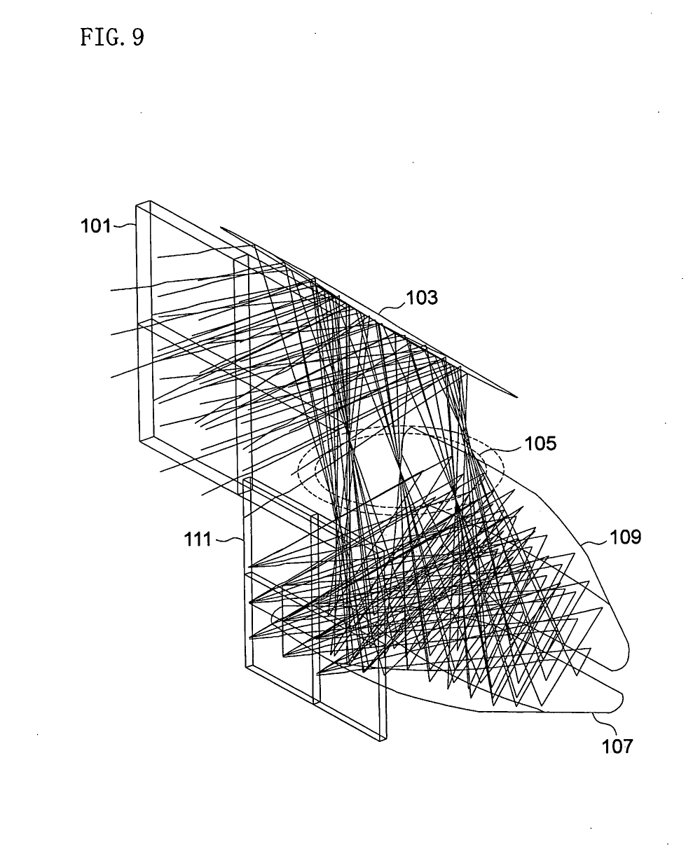

FIG. 9 shows a configuration of the imaging optical system of Example 2.

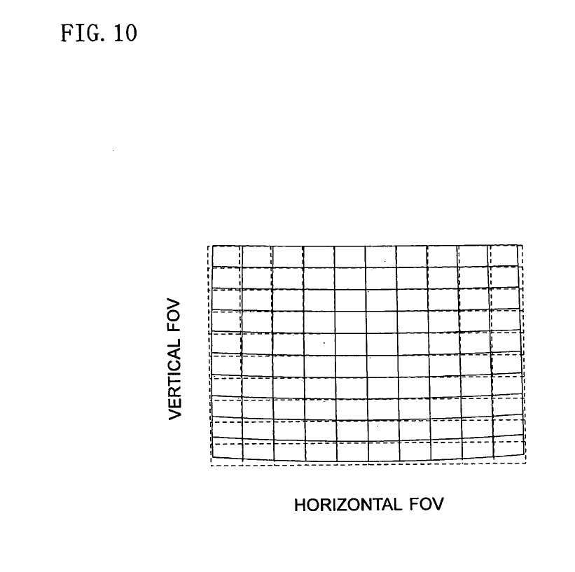

FIG. 10 shows distortion aberration of the imaging optical system of Example 2. The dashed line shows the reference lattice.

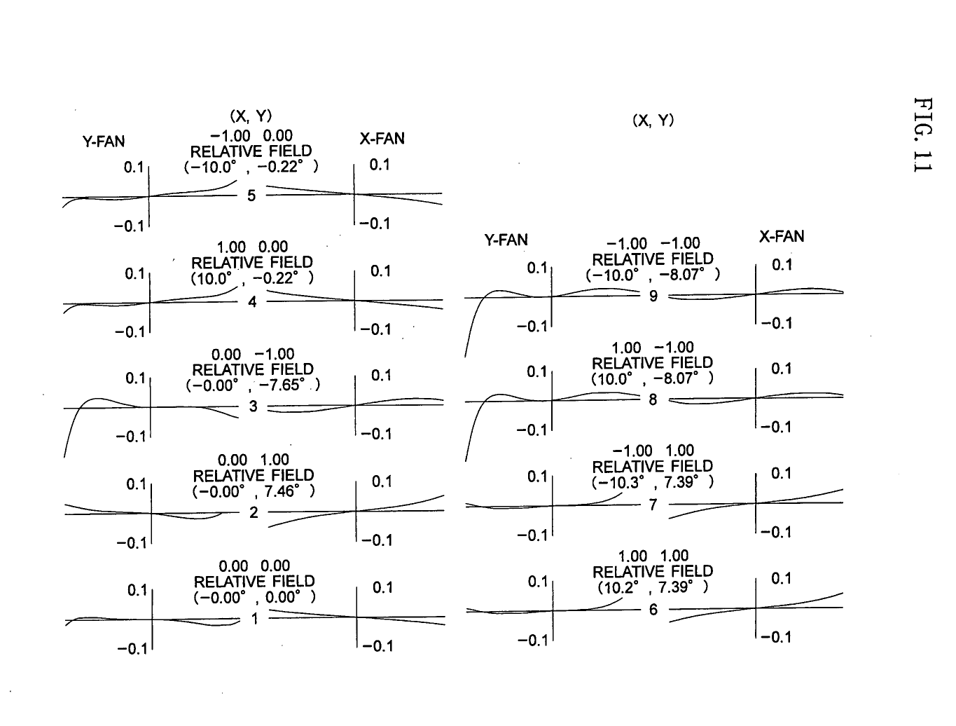

FIG. 11 shows transverse aberration of the imaging optical system of Example 2. FIG. 11 shows transverse aberration with respect to meridional image surface (Y-FAN) and sagittal image surface (X-FAN). The horizontal axis indicates the relative position where the beam passes on the surface stop on the respective image surfaces.

The position of principal ray L is zero and the outermost positions in the aperture radial direction is ±1, respectively. The vertical axis indicates amount of displacement D from the principal ray on the image surface, of positions on the image surface through which the beams that have passed through the relative positions pass, when the coordinate on the image surface through which the principal rays L on the respective image surfaces pass is zero (FIG. 32). In FIG. 11, (X,Y) show the positions on the image surface where transverse aberration is observed. That is, FIG. 11 shows transverse aberration with respect to nine points on the image surface represented by (X,Y). The size of the image surface is 12 millimeters in the X-axis direction and 9 millimeters in the Y-axis direction, and (−1,0) indicates coordinates (−6,0) and (0,1) indicates coordinates (0,4.5), for example. An angular vector represents an angle of X-component and Y-component incident in the optical system of beams collecting on a point on the image surface to be observed.

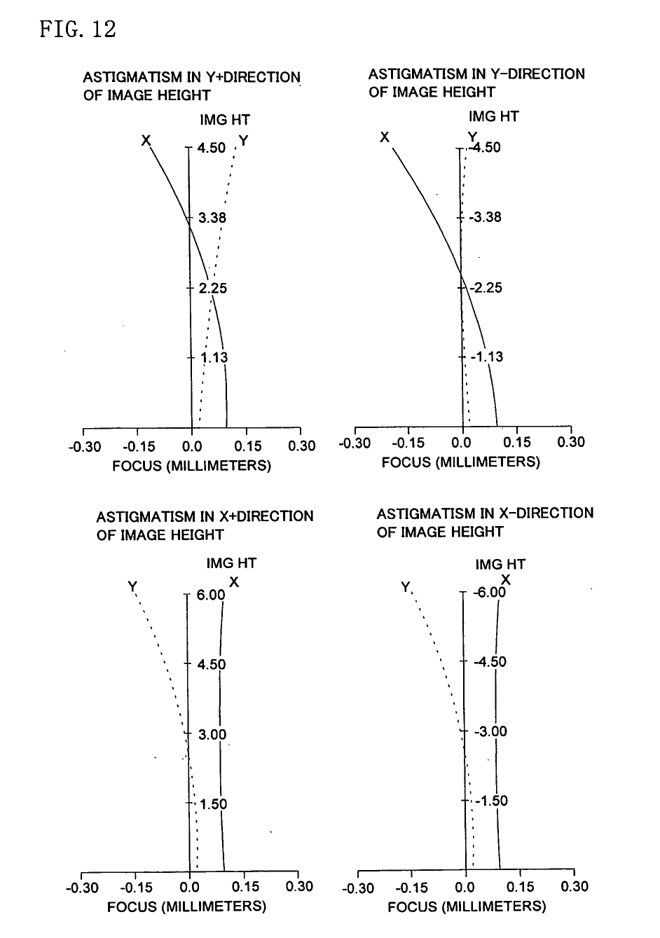

FIG. 12 shows astigmatism of the imaging optical system of Example 2. In FIG. 12, the horizontal axis indicates the position in the Z-axis direction with reference to the image surface and the vertical axis indicates the image height in the X-axis or Y-axis direction. In the drawing showing the image height in the Y-axis direction, the solid line shows the sagittal image surface and the dashed line shows the meridional image surface. In the drawing showing the image height in the X-axis direction, the solid line shows the meridional image surface and the dashed line shows the sagittal image surface.

### EXAMPLE 3

Table 6 shows specifications of an imaging optical system of Example 3.

TABLE 6

| | | Origin | Origin | Origin | Rotation | | |
|---|---|---|---|---|---|---|---|
| | | Point | Point | Point | angle | | |
| Surface | | position | position | position | YZ section | Refractive | |
| number | Note | X(mm) | Y(mm) | Z(mm) | (deg) | index | Surface shape |
| Object | Object surface | 0 | 0 | infinity | 0 | 1 | flat surface |
| surface | | | | | | | |
| surface 1 | Window plate | 0 | 0 | 0 | 0 | 4.003 | flat surface |
| Surface 2 | Window plate | 0 | 0 | 2 | 0 | 1 | flat surface |
| Surface 3 | First reflection | 0 | −3.186 | 20.570 | 39.636 | 1 | XY polynomial |
| | surface | | | | | | surface |
| Surface | Aperture | 0 | −17.825 | 17.495 | 82.000 | 1 | flat surface |
| stop | | | | | | | |
| Surface 5 | Second | 0 | −45.766 | 21.469 | 104.381 | 1 | XY polynomial |
| | reflection | | | | | | surface |
| | surface | | | | | | |
| Surface 6 | Third reflection | 0 | −33.312 | 0.431 | 153.081 | 1 | XY polynomial |
| | surface | | | | | | surface |
| Surface 7 | Window plate | 0 | −32.763 | 54.067 | 0.000 | 4.003 | flat surface |
| Surface 8 | Window plate | 0 | −32.763 | 55.067 | 0.000 | 1 | flat surface |
| Image | Image surface | 0 | −32.763 | 59.167 | 0.000 | 1 | flat surface |
| surface | | | | | | | |

In Table 6, an origin point position is a position of the origin point of local coordinates of each surface, with reference to the origin point O in FIGS. 1 and 2. The rotation angle is a rotation angle around X-axis of local coordinates and a counterclockwise angle with reference to the coordinate system in FIGS. 1 and 2 in YZ section.

Table 7 shows coefficients that determine the shapes of the first to third reflection surfaces.

TABLE 7

| | Surface 3 | Surface 5 | Surface 6 |
|---|---|---|---|
| X2 | 4.45E−03 | 2.30E−03 | −5.22E−03 |
| Y2 | 2.11E−03 | 3.55E−03 | −5.17E−03 |
| X2Y | −1.09E−05 | −2.49E−05 | −9.28E−06 |
| Y3 | −3.99E−05 | −1.37E−04 | −6.14E−05 |
| X4 | 1.15E−06 | −2.11E−07 | −2.51E−07 |
| X2Y2 | 1.45E−06 | −3.47E−07 | −1.21E−06 |
| Y4 | 1.05E−06 | 3.77E−06 | −1.58E−06 |
| X4Y | 3.28E−09 | 0.00E+00 | 2.60E−08 |
| X2Y3 | −4.25E−08 | −5.27E−08 | −3.10E−08 |
| Y5 | −2.47E−08 | −1.39E−07 | −5.61E−08 |
| Y6 | 0.00E+00 | 0.00E+00 | −1.17E−09 |
| X6Y | 0.00E+00 | 0.00E+00 | −1.54E−10 |
| X2Y6 | 0.00E+00 | 0.00E+00 | −3.51E−12 |
| X8Y | 0.00E+00 | 0.00E+00 | 2.88E−13 |
| Y9 | 0.00E+00 | 0.00E+00 | −2.24E−13 |

The shapes of the first to third reflection surfaces can be expressed by the following equation with local coordinates of the respective surfaces.

$$Z = C 4 \times {X}^{2} + C 5 \times XY + C 6 \times {Y}^{2} + C 7 \times {X}^{3} + C 8 \times {X}^{2} Y + C 9 \times {XY}^{2} + C 10 \times {Y}^{3} + C 11 \times {X}^{4} + C 12 \times {X}^{3} Y + C 13 \times {X}^{2} {Y}^{2} + C 14 \times {XY}^{3} + C 15 \times {Y}^{4} + ⋯ + C 66 \times {Y}^{10} \qquad [ Equation 3 ]$$

According to Table 7, the equation expressing the shapes of the first to third reflection surfaces contains terms of powers of odd numbers of Y. This indicates that the YZ section shapes of the first to third reflection surfaces are asymmetric with respect to Z-axis of local coordinates. In the embodiment, a change in inclination of the optical axis in the YZ section becomes larger because the aperture is provided between the first reflecting mirror 103 and the second reflecting mirror 107 so as to block stray light. Therefore, when the YZ section shape is symmetric with respect to Z-axis of local coordinates, the comatic aberration or astigmatism becomes larger. Accordingly, the YZ section shape is made asymmetric with respect to Z-axis of local coordinates for reducing the comatic aberration or astigmatism.

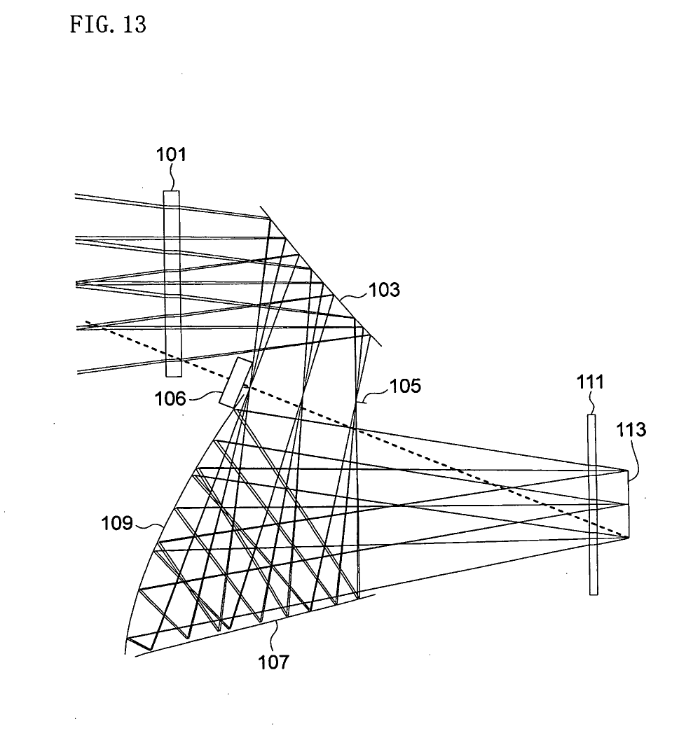

FIG. 13 is a YZ sectional view of the imaging optical system of Example 3. In the embodiment, the optical axis at the center of the field of view and the optical axis of the image surface are in parallel and the same in orientation. In the embodiment, a light shielding plate 106 for shielding the light from the object side directly toward the image surface is provided. By the aperture 105, the space for the light shielding plate 106 is secured.

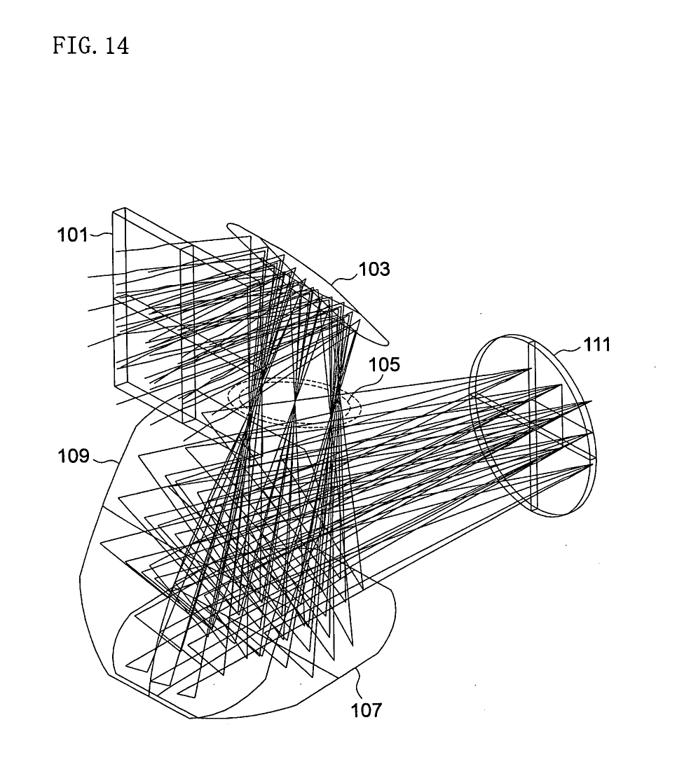

FIG. 14 shows a configuration of the imaging optical system of Example 3.

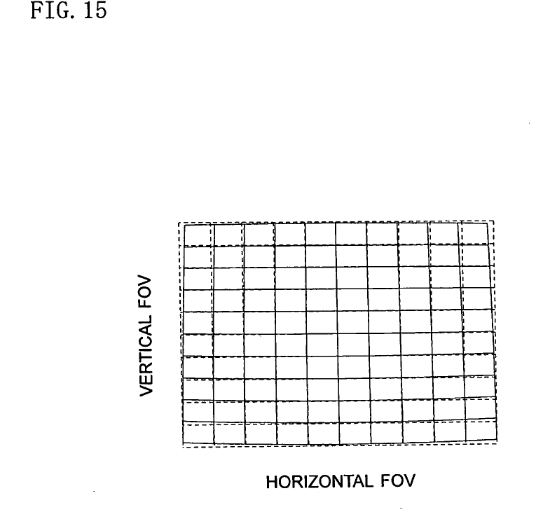

FIG. 15 shows distortion aberration of the imaging optical system of Example 3. The dashed line shows the reference lattice.

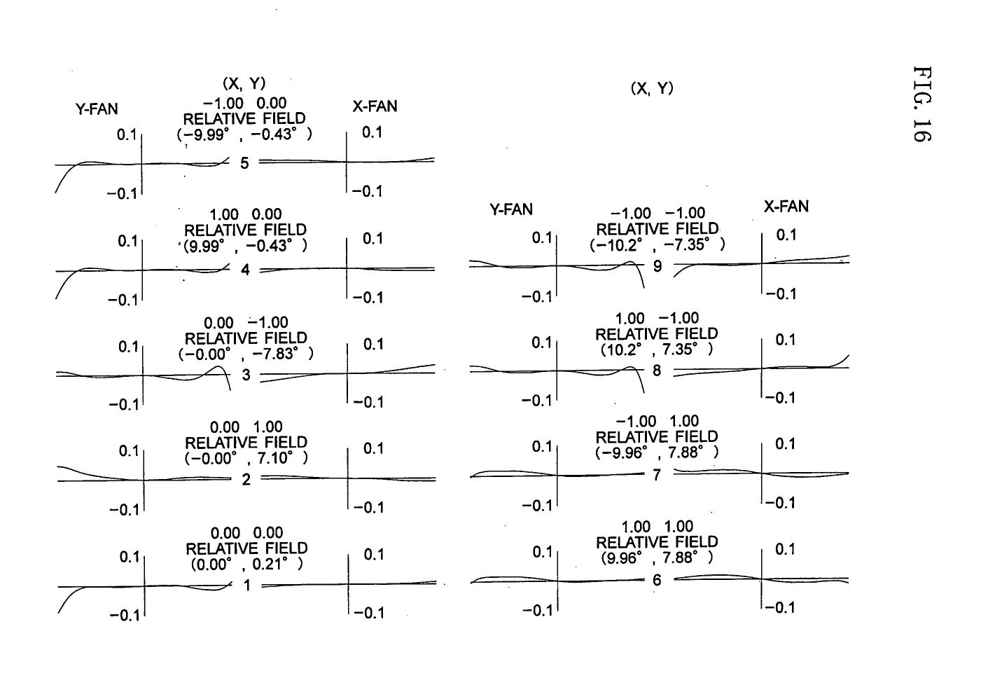

FIG. 16 shows transverse aberration of the imaging optical system of Example 3. FIG. 16 shows transverse aberration with respect to meridional image surface (Y-FAN) and sagittal image surface (X-FAN). The horizontal axis indicates the relative position where the beam passes on the surface stop on the respective image surfaces. The position of principal ray L is zero and the outermost positions in the aperture radial direction is ±1, respectively. The vertical axis indicates amount of displacement D from the principal ray on the image surface, of positions on the image surface through which the beams that have passed through the relative positions pass, when the coordinate on the image surface through which the principal rays L on the respective image surfaces pass is zero (FIG. 32). In FIG. 16, (X,Y) show the positions on the image surface where transverse aberration is observed. That is, FIG. 16 shows transverse aberration with respect to nine points on the image surface represented by (X,Y). The size of the image surface is 12 millimeters in the X-axis direction and 9 millimeters in the Y-axis direction, and (−1,0) indicates coordinates (−6,0) and (0,1) indicates coordinates (0,4.5), for example. An angular vector represents an angle of X-component and Y-component incident in the optical system of beams collecting on a point on the image surface to be observed.

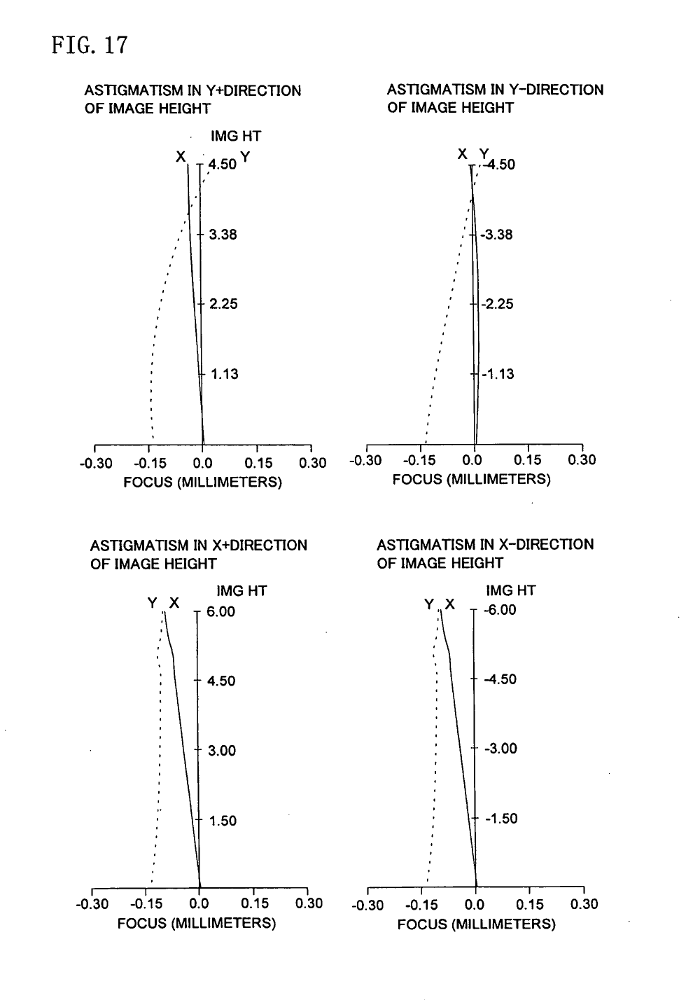

FIG. 17 shows astigmatism of the imaging optical system of Example 3. In FIG. 17, the horizontal axis indicates the position in the Z-axis direction with reference to the image surface and the vertical axis indicates the image height in the X-axis or Y-axis direction. In the drawing showing the image height in the Y-axis direction, the solid line shows the sagittal image surface and the dashed line shows the meridional image surface. In the drawing showing the image height in the X-axis direction, the solid line shows the meridional image surface and the dashed line shows the sagittal image surface.

### EXAMPLE 4

Table 8 shows specifications of an imaging optical system of Example 4.

TABLE 8

| | | Origin | Origin | Origin | Rotation | | |
|---|---|---|---|---|---|---|---|
| | | Point | Point | Point | angle | | |
| Surface | | position | position | position | YZ section | Refractive | |
| number | Note | X(mm) | Y(mm) | Z(mm) | (deg) | index | Surface shape |
| Object | Object surface | 0 | 0 | infinity | 0 | 1 | flat surface |
| surface | | | | | | | |
| Surface 1 | Window plate | 0 | 0 | 0 | 0 | 4.003 | flat surface |
| Surface 2 | Window plate | 0 | 0 | 2 | 0 | 1 | flat surface |
| Surface 3 | First reflection | 0 | 0.000 | 20.000 | 39.000 | 1 | XY polynomial |
| | surface | | | | | | surface |
| Surface | Aperture | 0 | −17.607 | 16.258 | 78.000 | 1 | flat surface |
| stop | | | | | | | |
| Surface 5 | Second | 0 | −49.886 | 9.397 | 103.000 | 1 | XY polynomial |
| | reflection | | | | | | surface |
| | surface | | | | | | |
| Surface 6 | Third | 0 | −33.337 | −3.532 | 154.000 | 1 | XY polynomial |
| | reflection | | | | | | surface |
| | surface | | | | | | |
| Surface 7 | Window plate | 0 | −33.337 | 30.468 | 0.000 | 4.003 | flat surface |
| Surface 8 | Window plate | 0 | −33.337 | 43.468 | 0.000 | 1 | flat surface |
| Image | Image surface | 0 | −33.337 | 44.468 | 0.000 | 1 | flat surface |
| surface | | | | | | | |

In Table 8, an origin point position is a position of the origin point of local coordinates of each surface, with reference to the origin point O in FIGS. 1 and 2. The rotation angle is a rotation angle around X-axis of local coordinates and a counterclockwise angle with reference to the coordinate system in FIGS. 1 and 2 in YZ section.

Table 9 shows coefficients that determine the shapes of the first to third reflection surfaces.

TABLE 9

| | Surface 3 | Surface 5 | Surface 6 |
|---|---|---|---|
| X2 | 3.25E−03 | 2.11E−03 | −5.14E−03 |
| Y2 | 2.43E−03 | 2.67E−03 | −3.36E−03 |
| X2Y | 5.12E−06 | −3.60E−06 | 1.97E−05 |
| Y3 | −2.31E−05 | −3.39E−05 | −9.79E−06 |
| X4 | 6.85E−07 | −1.16E−07 | −2.54E−07 |
| X2Y2 | 1.06E−06 | −3.72E−07 | −5.50E−07 |
| Y4 | 6.22E−07 | −5.14E−07 | −5.92E−07 |
| X4Y | 3.64E−09 | 1.05E−09 | 2.03E−09 |
| X2Y3 | −7.70E−09 | −4.35E−09 | 8.36E−10 |
| Y5 | −8.91E−09 | −2.21E−08 | −1.81E−08 |

The shapes of the first to third reflection surfaces can be expressed by the following equation with local coordinates of the respective surfaces.

$$Z = C 4 \times {X}^{2} + C 5 \times XY + C 6 \times {Y}^{2} + C 7 \times {X}^{3} + C 8 \times {X}^{2} Y + C 9 \times {XY}^{2} + C 10 \times {Y}^{3} + C 11 \times {X}^{4} + C 12 \times {X}^{3} Y + C 13 \times {X}^{2} {Y}^{2} + C 14 \times {XY}^{3} + C 15 \times {Y}^{4} + ⋯ + C 66 \times {Y}^{10} \qquad [ Equation 4 ]$$

According to Table 9, the equation expressing the shapes of the first to third reflection surfaces contains terms of powers of odd numbers of Y. This indicates that the YZ section shapes of the first to third reflection surfaces are asymmetric with respect to Z-axis of local coordinates. In the embodiment, a change in inclination of the optical axis in the YZ section becomes larger because the aperture is provided between the first reflecting mirror 103 and the second reflecting mirror 107 so as to block stray light. Therefore, when the YZ section shape is symmetric with respect to Z-axis of local coordinates, the comatic aberration or astigmatism becomes larger. Accordingly, the YZ section shape is made asymmetric with respect to Z-axis of local coordinates for reducing the comatic aberration or astigmatism.

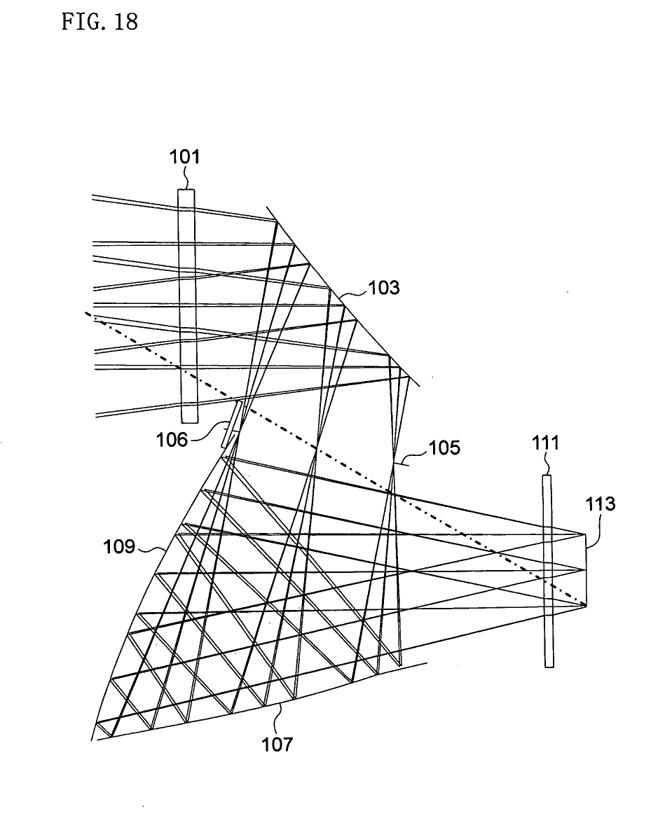

FIG. 18 is a YZ sectional view of the imaging optical system of Example 4. In the embodiment, the optical axis at the center of the field of view and the optical axis of the image surface are in parallel and the same in orientation. In the embodiment, a light shielding plate 106 for shielding the light from the object side directly toward the image surface. By the aperture 105, the space for the light shielding plate 106 is secured.

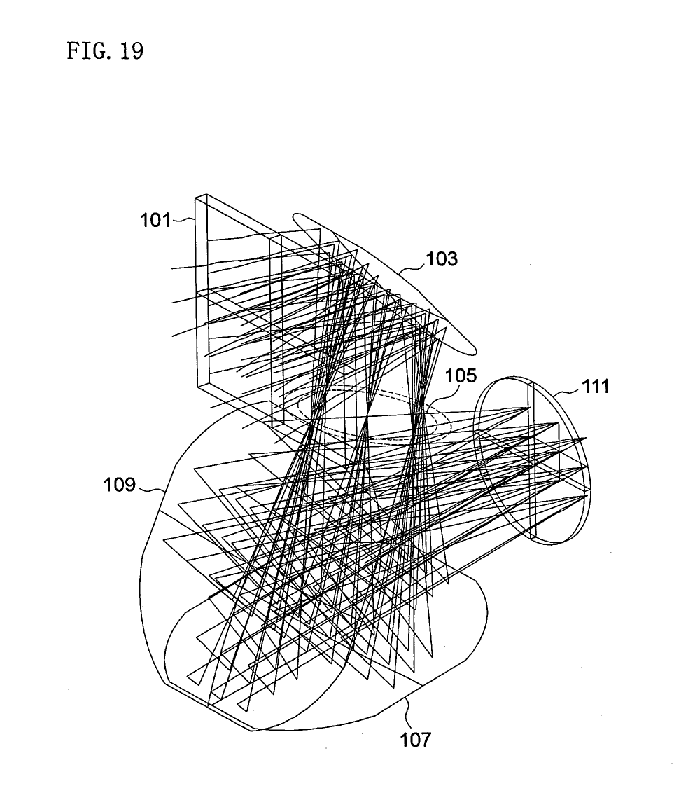

FIG. 19 shows a configuration of the imaging optical system of Example 4.

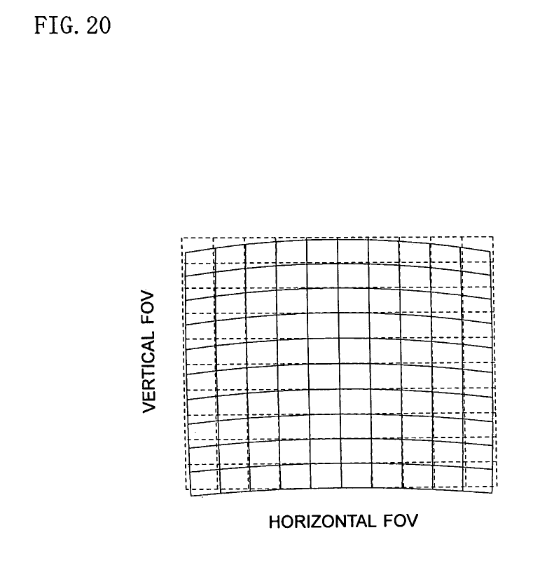

FIG. 20 shows distortion aberration of the imaging optical system of Example 4. The dashed line shows the reference lattice.

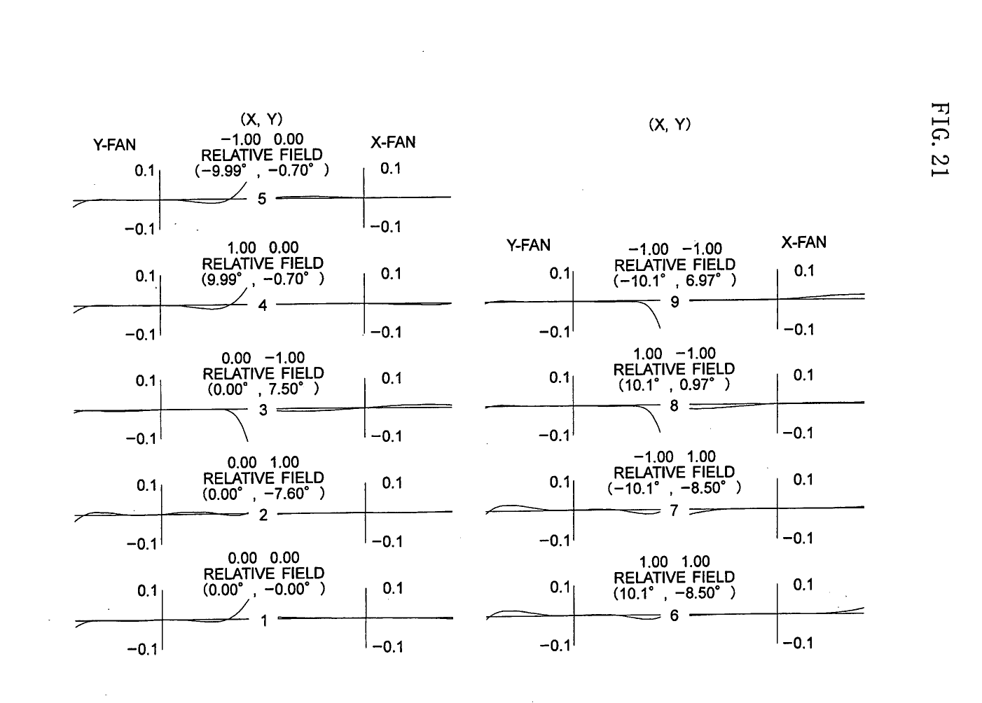

FIG. 21 shows transverse aberration of the imaging optical system of Example 4. FIG. 21 shows transverse aberration with respect to meridional image surface (Y-FAN) and sagittal image surface (X-FAN). The horizontal axis indicates the relative position where the beam passes on the surface stop on the respective image surfaces. The position of principal ray L is zero and the outermost positions in the aperture radial direction is ±1, respectively. The vertical axis indicates amount of displacement D from the principal ray on the image surface, of positions on the image surface through which the beams that have passed through the relative positions pass, when the coordinate on the image surface through which the principal rays L on the respective image surfaces pass is zero (FIG. 32). In FIG. 21, (X,Y) show the positions on the image surface where transverse aberration is observed. That is, FIG. 21 shows transverse aberration with respect to nine points on the image surface represented by (X,Y). The size of the image surface is 12 millimeters in the X-axis direction and 9 millimeters in the Y-axis direction, and (−1,0) indicates coordinates (−6,0) and (0,1) indicates coordinates (0,4.5), for example. An angular vector represents an angle of X-component and Y-component incident in the optical system of beams collecting on a point on the image surface to be observed.

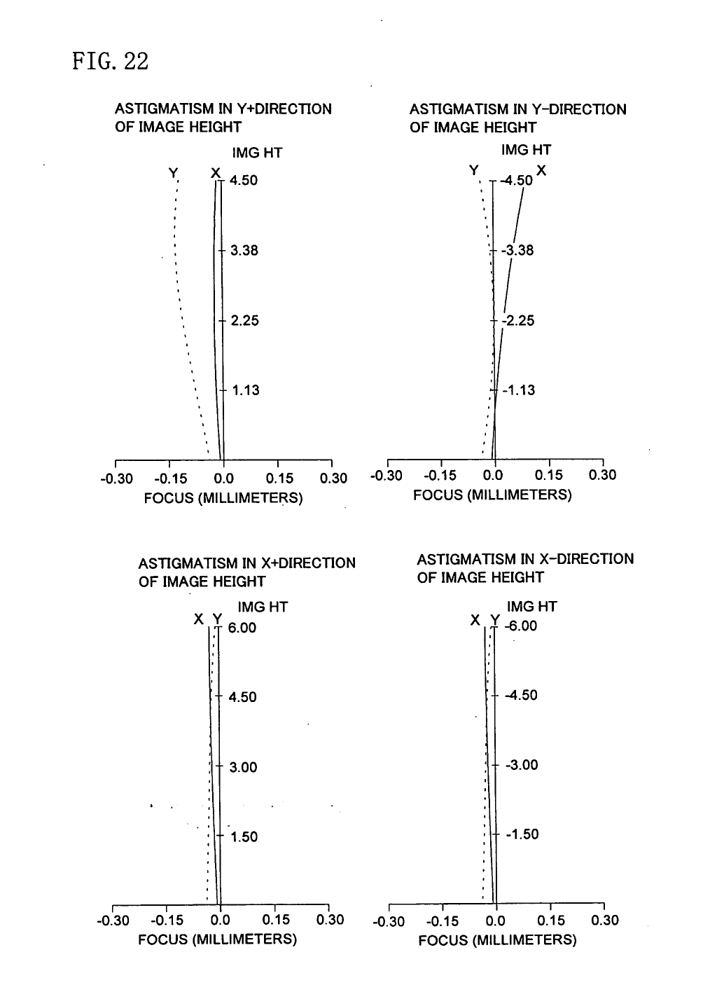

FIG. 22 shows astigmatism of the imaging optical system of Example 4. In FIG. 22, the horizontal axis indicates the position in the Z-axis direction with reference to the image surface and the vertical axis indicates the image height in the X-axis or Y-axis direction. In the drawing showing the image height in the Y-axis direction, the solid line shows the sagittal image surface and the dashed line shows the meridional image surface. In the drawing showing the image height in the X-axis direction, the solid line shows the meridional image surface and the dashed line shows the sagittal image surface.

### Product of Imaging Optical System

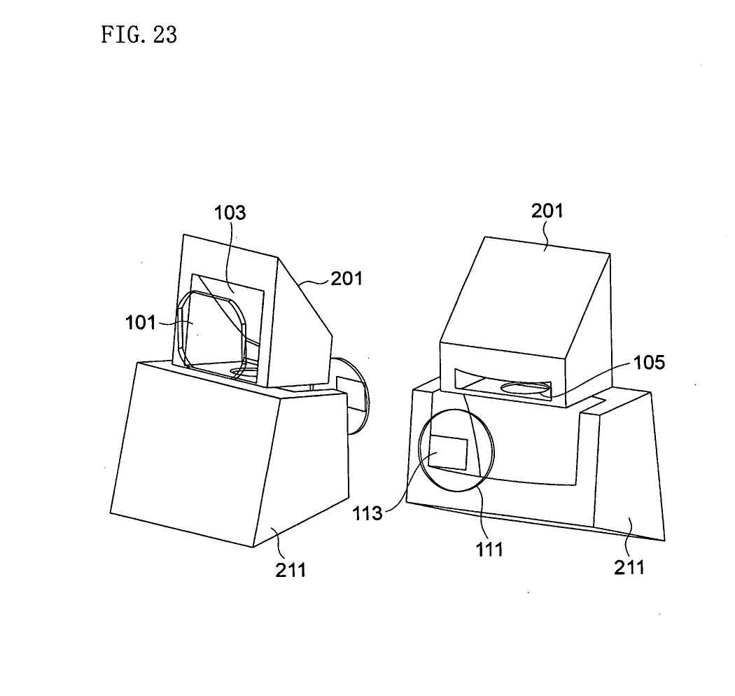

FIG. 23 shows a configuration of an imaging optical system as a product according to one embodiment of the invention. The first reflecting mirror 103 and the aperture 105 are formed as a molded component 201, and the second reflecting mirror 107 and the third reflecting mirror 109 are formed as a molded component 211.

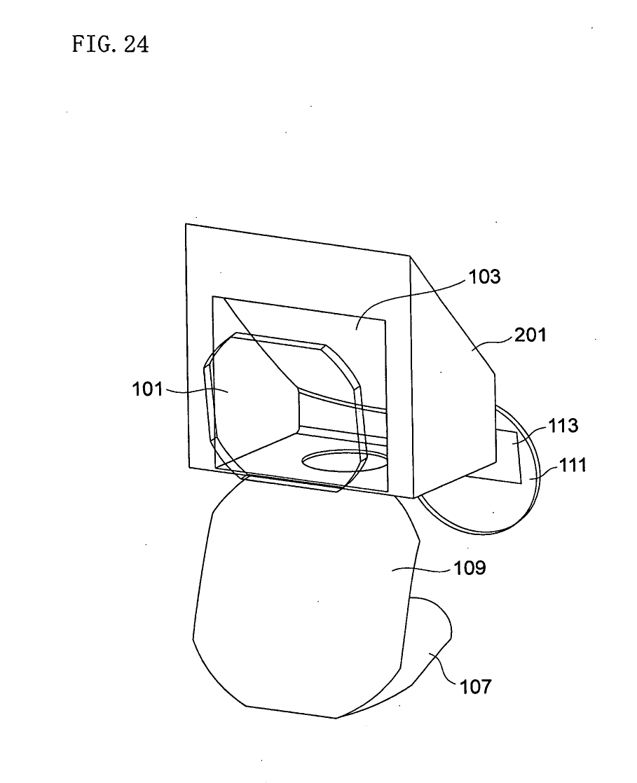

FIG. 24 shows one embodiment of the molded component 201 including the first reflecting mirror 103 and the aperture 105.

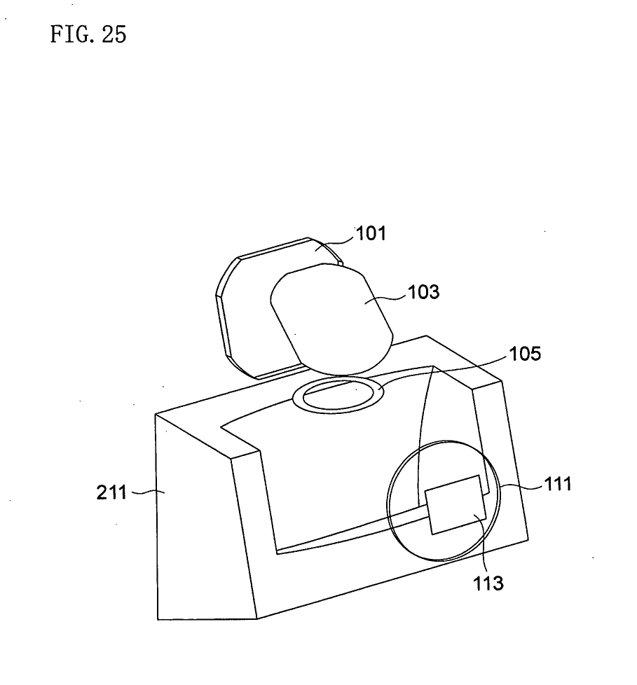

FIG. 25 shows one embodiment of the molded component 211 including the second reflecting mirror 107 and the third reflecting mirror 109. It has a vibration-resistant box structure.

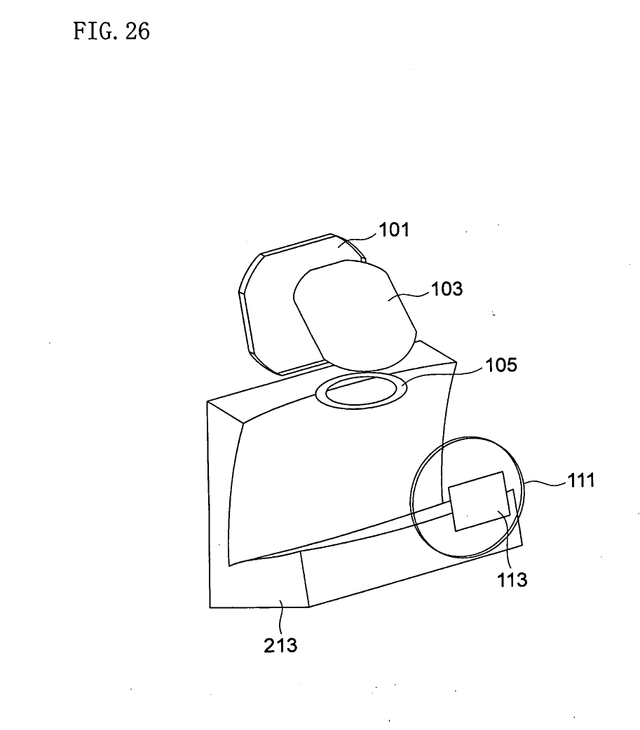

FIG. 26 shows another embodiment of the molded component 211 including the second reflecting mirror 107 and the third reflecting mirror 109.

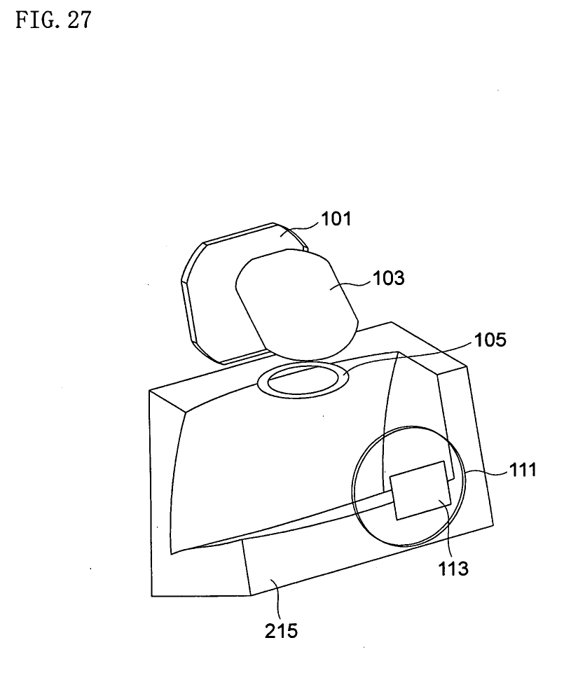

FIG. 27 shows still another embodiment of the molded component 211 including the second reflecting mirror 107 and the third reflecting mirror 109.

### Rangefinder

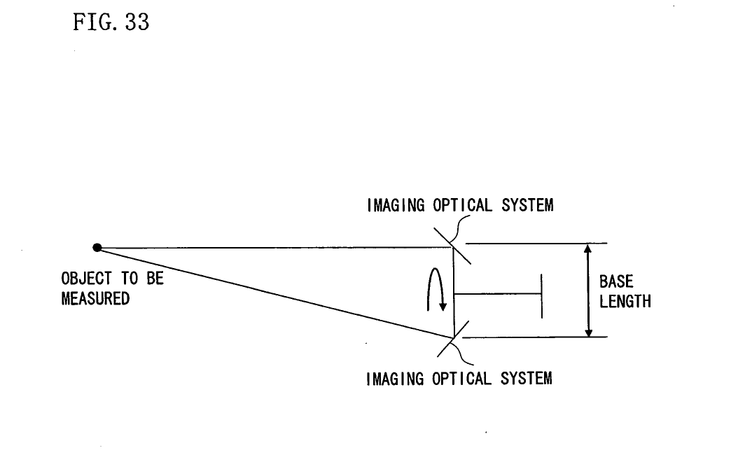

FIG. 33 shows the concept of a rangefinder. In order to measure and determine the distance to an object (subject), the object is imaged from different view points and obtained images are searched for corresponding points of the respective pixels between the images. The distance to the object can be obtained based on the parallax between corresponding pixels. Here, the distance between different view points is referred to as base length. Therefore, in the typical rangefinder, two imaging optical systems provided separately with the base length in between are used.

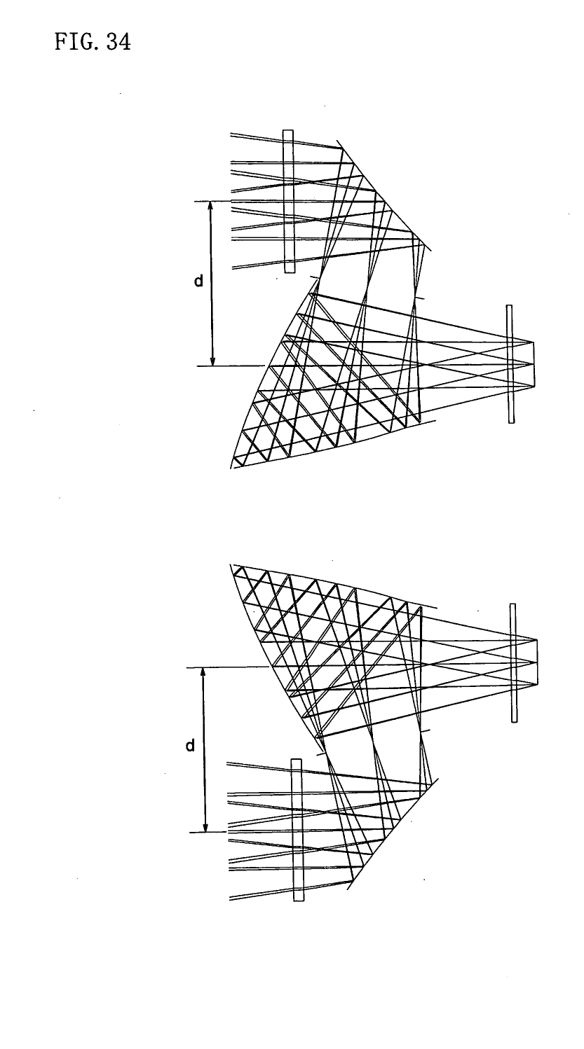

FIG. 34 shows a configuration of the imaging optical system of Example 4 and a configuration in which the imaging optical system is rotated to 180 degrees around the optical axis of the image surface. d is about 33 millimeters and a rangefinder of about 66 millimeters in base length is realized by one imaging optical system according to the configuration. In an infrared camera, the cost of a cooling system in a light receiving part is high in addition to that of the optical system. Therefore, the cost is drastically reduced using only one optical system.

According to the invention, a compact imaging optical system using reflecting mirrors that can be equipped and used in a vehicle or the like can be obtained.

What is claimed is:

1. An imaging optical system comprising three reflecting mirrors and configured, when an XYZ orthogonal coordinate system using an optical axis at the center of the field of view as Z-axis is determined, so that the optical axis at the center of the field of view and an optical axis of an image surface may be in parallel by changing orientation of the optical axis in a YZ section while maintaining the orientation of the optical axis in an XZ section, wherein a shape of a YZ section in local coordinates of at least one reflecting mirror is made asymmetric with respect to Z-axis of the local coordinates, for reducing aberration.

2. The imaging optical system according to claim 1, wherein an aperture is provided between two of the reflecting mirrors adjacent along an optical path.

3. The imaging optical system according to claim 1, wherein the most upstream reflecting mirror in the optical path has a convex surface and the most downstream reflecting mirror along the optical path has a concave surface.

4. The imaging optical system according to claim 1, which is a non-relay optical system that does not perform intermediate imaging.

5. The imaging optical system according to claim 1, wherein the optical axis at the center of the field of view and the optical axis of the image surface are different in orientation.

6. The imaging optical system according to claim 1, wherein the optical axis at the center of the field of view and the optical axis of the image surface are the same in orientation.

7. The imaging optical system according to claim 6, comprising a light shielding plate so that the light other than the light from the most downstream reflecting mirror along the optical path may not enter the image surface.

8. The imaging optical system according to claim 1, wherein the reflecting mirror is made of plastic coated with metal.

9. The imaging optical system according to claim 1, which is used for infrared light.

10. A rangefinder configured so that the imaging optical system according to claim 1 may be rotated to 180 degrees around an optical axis incident to the image surface.
